(19) United States
(12) Patent Application Publication
(10) Pub. No.: US 2003/0132578 A1
(43) Pub. Date: Jul. 17, 2003

(54) Method and apparatus for providing a sealing gasket on a tubular element

(76) Inventor: Lars E.W. Nilsson, Riverside, CT (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/044,293

(22) Filed: Jan. 11, 2002

(51) Int. Cl. F16L 21/05

(52) U.S. Cl. 277/603

(57) ABSTRACT

A method of manufacturing a tubular element that has a sealing gasket arranged around its external surface comprises the steps of: providing a continuous sealing strip; forming the sealing strip into a shape that essentially corresponds to a perimeter of the tubular element; cutting the sealing strip into a sealing strip portion having a length that essentially corresponds to the perimeter of the tubular element; joining together a first and a second end of the sealing strip portion, so as to form the sealing gasket; and fastening the sealing gasket around the perimeter of the tubular element. An apparatus for manufacturing such a tubular element has means for carrying out the steps.

### FIELD OF THE INVENTION

The present invention relates to a method of manufacturing a tubular element that has a sealing gasket arranged around its external surface, an apparatus for manufacturing a tubular element having a sealing gasket arranged around its external surface and a ventilation duct component comprising a thin-walled, essentially tubular structure, having a sealing gasket arranged around its perimeter.

### BACKGROUND OF THE INVENTION

Ventilation systems and exhaust or evacuation systems often comprise tubular elements such as pipes or ducts for transportation of air or finely divided materials such as dust, sawdust etc. Such pipes or ducts are typically made from sheet metal, such as zincified steel, stainless steel, aluminum etc. The duct components are usually formed by helically winding a strip of sheet metal into a tubular element, while folding together the longitudinal edges of the metal strip into a helical lock seam so as to form a continuous duct wall.

The cross section of the duct components and/or their openings may have different shapes, such as e.g. square, rectangular, circular or oval. Hence, an “essentially tubular structure” should be understood so as to comprise elements having other cross sections than circular ones. Naturally, the cross sections may also be of different sizes. Furthermore, the duct components may have different shapes with respect to the duct system, such as straights, bends or elbows, reducers, branches or manifolds. The duct component may also comprise functional components such as e.g. silencers, valves, measuring equipment, filters, fans or terminal devices such as grilles and diffusers. Hence, the expression “duct component” should be understood to comprise any component that may be arranged in fluid communication with other components in a ventilation system and that may need a sealing gasket.

The duct components have at least one opening through which they may be arranged in such fluid communication with other duct components or other components in the ventilation system.

When joining together duct components into forming a e.g. continuous duct, it is normally desirable to keep the amount of leakage from the duct to the surrounding environment, or vice versa, to a minimum. Whereas the duct walls generally provide sufficient leakproofness for this purpose, this is not always the case with the duct component joints, since the shape of the openings or end portions of the duct components or other components may vary slightly due to e.g. imperfections in the manufacturing process, temperature changes etc.

Sealed duct component joints may be achieved by using e.g. adhesive tape, cement, sealing paste etc, which is applied in or around the joint. Obviously, while being cheap and simple, such methods of sealing the duct component joint have drawbacks: for example, the seal may make disassembly for purposes such as inspection, recycling or cleaning difficult. Furthermore, the use of such sealing means may increase the time required for installation and have a negative impact on the work environment for the operator effecting the installation. It may also be difficult to achieve installation consistency, since the quality of each seal is dependent on the installer's skills. Also seals using adhesive components such as tapes, cement, pastes etc. may deteriorate and thus not provide the desired long-term tightness.

Another known method of sealing a duct component joint is to provide a prefabricated flexible gasket around e.g. an end portion of a pipe. Such a flexible gasket typically has a shape that allows it to be arranged around the exterior of the duct component. The flexible gasket typically has a profile which is appropriate for providing a seal around a perimeter of a first duct component, when a second duct component is arranged so as to overlap and enclose the end portion of the first duct component. The sealing may be effected by use of one or more lips, extending at least partly radially from the first duct component. The sealing gasket may be produced from flexible polymer materials such as rubber (frequently EPDM rubber) or rubber-like materials such as e.g. silicone, polyurethane, thermoplastic elastomers etc.

In some cases, it is desirable to fasten the flexible sealing gasket to the duct component to a greater degree than what is allowed by e.g. the mere tight fitting of the gasket around the duct component end portion. One known way of doing this is by providing the sealing gasket with a profile that has a certain extension in the axial direction of the duct component, whereby the axial extension is arranged near the edge of the duct component end so that the outer edge part of the duct component end is folded outwardly over the extension, so that the extension of the sealing gasket is squeezed between the folded duct component edge and the unfolded part of the duct component edge.

Another way of fastening the gasket is to provide a circumferential clamp, which typically comprises a metal strap and a locking mechanism. After the gasket has been applied to the end portion of the duct component, the clamping strap is arranged around the gasket, tightened and fastened, so that the gasket is squeezed between the clamping strap and the duct component.

Yet another known way of fastening the sealing gasket is by arranging it in a recess or groove in the duct component exterior, so that movement of the sealing gasket in the axial direction of the duct component is prevented or at least reduced. It is also possible to glue the sealing gasket to the perimeter of the duct component. Of course, the above methods for fastening the sealing gasket may be used in combination.

Prior art techniques for providing sealing gaskets on ventilation duct components are disclosed in U.S. Pat. Nos. 3,955,834; 4,050,703; 5,531,460; 6,170,883 and in European Patent Publication No. 0 389 462, all of which are hereby incorporated by reference.

Whereas the application of rubber sealing gaskets is a very attractive way of sealing the joint between two duct components, they nevertheless suffer from a disadvantage in that they have to be fabricated to fit the size of the duct component on which they are to be applied. Hence, a manufacturer that wishes to manufacture sealed duct components having different cross sections, also needs to manufacture or have manufactured a corresponding number of different sealing gaskets. The costs of designing, storing and producing such a selection of different sealing gaskets may be considerable.

### SUMMARY OF THE INVENTION

It is therefore an object of the present invention to provide a method and an apparatus for arranging a sealing gasket around an external surface of a tubular element, a method and an apparatus for manufacturing such tubular elements having sealing gaskets as well as a ventilation duct component, which at least partly overcome these drawbacks.

These and other objectives are achieved wholly or partially by a method comprising the steps of any of the appended independent claim 1, by an apparatus comprising the features of any one of independent claims 21 or 31 or by a ventilation duct component comprising the features according to independent claim 33. Preferred embodiments are set forth in the appended dependent claims and in the following description.

According to a first aspect of the present invention, there is provided a method of manufacturing a tubular element having a sealing gasket arranged around an external surface thereof. The method comprises the steps of: providing a continuous sealing strip; forming the sealing strip into a shape that essentially corresponds to a perimeter of the tubular element; cutting the sealing strip into a sealing strip portion having a length that essentially corresponds to the perimeter of the tubular element; joining together a first and a second end of the sealing strip portion, so as to form the sealing gasket; and fastening the sealing gasket around the perimeter of the tubular element.

According to a second aspect of the invention, there is provided an apparatus for manufacturing a tubular element having a sealing gasket arranged around its external surface. The apparatus comprises: a sealing strip feeder for feeding a sealing strip; a sealing strip winder for forming the sealing strip into a sealing gasket for the tubular element; a cutter for cutting the sealing strip into a sealing strip portion having a length which essentially corresponds to the perimeter of the tubular element; and a joiner for joining together a first and a second end of the sealing strip portion, so as to form the sealing gasket.

According to a third aspect of the invention a ventilation duct component is provided, which comprises a thin-walled, essentially tubular structure having a sealing gasket arranged around its perimeter, said sealing gasket comprising a sealing strip having a profiled cross section and two end portions, which are joined together so as to form an essentially continuous sealing gasket.

The present invention provides advantages over the prior art. Instead of purchasing and/or producing sealing gaskets for each duct component size and shape, only continuous bulk sealing strip having the desired profile needs to be acquired and kept in store. The sealing gasket is produced at the time the duct component is produced and does not need to be stored separately. This leads to a potential for reducing the amount of work in progress and thereby the need for working capital.

In one embodiment of the first aspect of the invention, the step of arranging the sealing strip may further comprise winding the sealing strip around a forming mandrel having a perimeter which is essentially equal to a perimeter of the tubular element and after joining together the first and second ends of the sealing strip portion, and transferring the sealing gasket onto the tubular element. Such a forming mandrel may be adapted for the circumference of the duct component on which the sealing gasket is to be applied. The forming mandrel may also have a variable cross section so as to fit different sizes or shapes of duct components. This embodiment enables the use of a robust machine design since the ability of the duct component to withstand the forces associated with the winding of the sealing strip may not need to be considered.

Alternatively, the sealing strip may be wound directly around the tubular element, provided that the pressure applied on the element when winding the sealing strip around it is not too large. If the pressure would be too large, then it is possible to provide the apparatus with a support member that is applied to the inside of the duct component or between the duct component and the sealing gasket and which is adapted to absorb the pressure from the gripping heads. This embodiment is advantageous since it may reduce the complexity, and thus cost, of the production apparatus.

Preferably, the sealing strip may be provided as a continuous sealing strip having a length that may be considerably larger than the circumference of the duct component to be fitted with a sealing gasket. Such continuous sealing strips may be provided on a supply such as e.g. a carrier in the form of a roll. Thus sealing strip may be purchased in large volumes, which may reduce costs.

When winding the sealing strip onto the tubular element or the forming mandrel, it is possible to hold a first end of the sealing strip against a point on the perimeter of the tubular element, while rotating the tubular element or the forming mandrel around a center axis of the tubular element or the portion of it where the sealing gasket is to be applied, so as to arrange the sealing strip around its perimeter.

The sealing strip may be axially fastened to the tubular element, so as to prevent it from being displaced and cause leakages. Such fastening may be achieved by e.g. clamping the sealing strip to the tubular element, providing a circumferential groove near the tubular element end portion and arranging the sealing strip in the groove, adhering the sealing strip to a surface of the tubular element or by folding an edge portion of the tubular element so as to squeeze the sealing strip portion between a folded edge portion and a non-folded portion of the tubular element.

The sealing gasket may be axially fastened to the tubular structure as described above and the ends of the sealing strip may be joined together by one of a gluing operation, a vulcanization operation, a welding operation and a heat treatment operation.

An opportunity provided by the invention is that instead of having production equipment for producing the sealing gasket and production equipment for applying it to the pipe, the production equipment may be more or less integrated into equipment for forming the sealing gasket and applying it to the duct component. It is also possible to provide equipment that has the capability of applying sealing gaskets to duct components having different size and/or cross section. Thus, there is a potential for reducing the amount of production equipment. Also, the need to invest in and maintain production equipment for the production of differently sized sealing gaskets may be reduced.

A ventilation duct component according to the third aspect of the invention will be provided with a sealing gasket that is continuous all the way around the perimeter of the component and that shows no, or very little, disruption, and thus leakage, due to the disruption caused by the meeting of the two sealing strip ends. At the same time, the ventilation duct component will be more economical to produce, since the need to produce and store sealing gaskets that are adapted for different sizes of duct components is reduced.

### BRIEF DESCRIPTION OF THE DRAWINGS

The invention will be described in more detail with reference to the appended schematic drawings, which show examples of presently preferred embodiments of the invention.

FIG. 1 is a perspective view showing a prior art duct component provided with a sealing gasket.

FIGS. 2-4 are schematic cross sectional views showing a part of a prior art duct component provided with a sealing gasket.

FIG. 5 illustrates an apparatus for arranging a sealing strip around a forming mandrel or a duct component.

FIGS. 6-13 are perspective views illustrating steps for providing a duct component with a sealing gasket in the system of FIG. 5.

FIG. 14 is a side view of the duct component inserted in the forming mandrel.

FIGS. 15-17 illustrate the function of the gripping heads and abutment throughout the process illustrated in FIGS. 6-13.

FIGS. 18-23 are perspective views illustrating alternative ways of joining together ends of a sealing strip.

FIG. 24 illustrates an alternative embodiment of an apparatus for arranging a sealing strip around a duct component.

### DESCRIPTION OF PREFERRED EMBODIMENTS

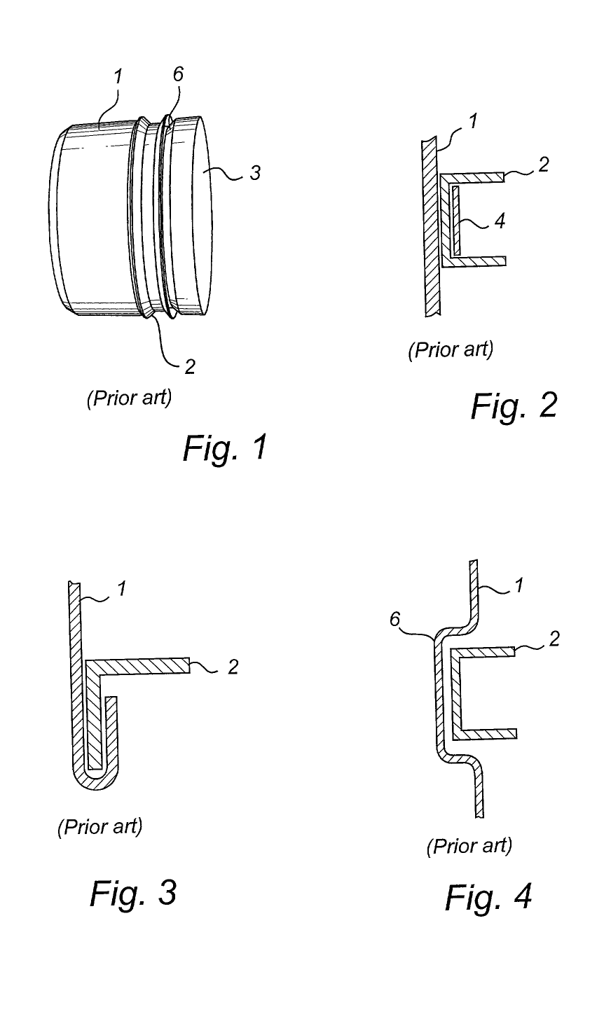

FIGS. 1-4 illustrate different prior art ways of arranging a sealing gasket 2 around an end portion of a tubular element 1, such as a ventilation duct component.

FIG. 1 illustrates a tubular element or a duct component 1 having a ring-shaped sealing gasket 2 arranged at an opening end 3. The sealing gasket 2 in FIG. 1 is arranged in a groove 6 around the perimeter of the duct component 1.

FIG. 2 illustrates a way of securing the sealing gasket 2 to the duct component 1, where a clamping strap 4 is arranged around the sealing gasket 2 and tightened, so that the gasket 2 is held in place by the friction between the sealing gasket 2 and the duct component 1 that is caused by the tightened clamping strap 4.

FIG. 3 illustrates a different way of securing the sealing gasket 2 to the duct component 1, where the sealing gasket 2 is arranged near the edge 3 of the duct component 1 and where the duct component edge portion is folded so as to squeeze the sealing gasket 2 between a folded edge portion and the unfolded edge portion.

FIG. 4 is a detailed view of the securing of the sealing gasket 2 to the duct component 1 of FIG. 1. Here, the sealing gasket 2 is arranged in a groove 6 around the perimeter of the duct component 1 so as to prevent it from being displaced.

It is also possible to merely secure the sealing gasket to the duct component by way of providing (not shown) a sealing gasket having a diameter which is smaller than an outer diameter of the duct component 1. That way, the flexibility of the sealing gasket is used to create a circumferential tension around the sealing gasket, which in turn generates a radial pressure between the sealing gasket and the duct component that together with the friction between the duct component and the gasket fastens the gasket to the duct component.

Yet another way is to provide the sealing gasket with an adhesive, such as e.g. glue or adhesive tape that makes the sealing gasket stick to the surface of the duct component (not shown).

Obviously, the above described methods may be combined, e.g. by securing a sealing gasket by using a clamping strap in combination with a groove or by using a sealing ring with smaller diameter together with the groove. Other combinations are also possible.

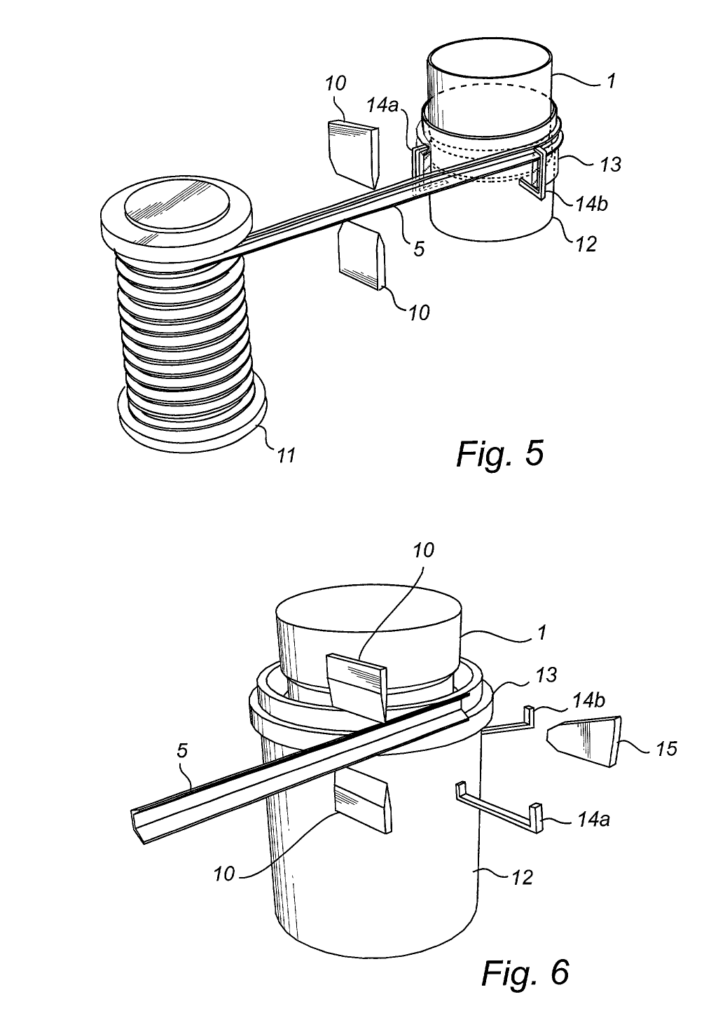

FIG. 5 illustrates an apparatus for manufacturing a pipe or a duct component 1 having a sealing gasket 2. A rotatable forming mandrel 12 is provided around which a sealing strip 5 is to be wound. The sealing strip 5 is fed from a supply, such as e.g. a carrier in the shape of a roll 11 from which the sealing strip 5 is unwound. The supply may also be a carrier for a sealing strip, whereon the sealing strip is provided in the form of essentially linear strips (not shown).

FIG. 5 further illustrates a cutter 10 for cutting the sealing strip 5 into a sealing strip portion, gripping heads 14a, 14b for holding the sealing strip 5 in a fixed position in relation to the forming mandrel 12, a joiner such as a splicing head 15 for joining together two ends 8a, 8b of the sealing strip portion 5 and an abutment 13 for enabling the sealing gasket 2 to move relative to the forming mandrel 12. FIG. 5 also shows a pipe or duct component 1, or a portion thereof, which is inserted into the forming mandrel 12.

The joiner 15 may comprise components for e.g. vulcanizing two ends of a sealing strip made of rubber. Such a joiner could comprise feeding means for e.g. components needed to provide a vulcanized joint between the two ends and a heater for providing heat needed for achieving the vulcanization. Of course, cold vulcanization, or alternative heating methods such as microwave or induction are also possible to use. It is also possible to use ultrasound techniques for the joining of the strip ends.

In another embodiment, the joiner 15 may simply be a surface that is suitable for interacting with the profile of the sealing strip and a heater for melting the sealing strip end portions enough to join them together. Naturally, it could also comprise or carry a fusible material which may act as a “plastic solder” for welding together the two ends (not shown).

Yet another possibility is that the joiner 15 comprises a glue applicator for applying a suitable type of glue. Such glue may be heat activated or composed of two or more components (not shown).

Preferably, the joiner 15 is capable of performing all functions necessary to join the two sealing strip ends. However, it is also possible that the joiner 15 be composed of more or less independently arranged components which are arranged to act upon a sealing strip joint in a predetermined sequence (not shown).

FIGS. 6-13 illustrates steps in the production of a duct component 1 having a sealing gasket 2.

In FIG. 6, the sealing strip 5 is fed towards the forming mandrel 12 and the duct component 1 is inserted in the forming mandrel 12. A first end 8a of the sealing strip 5 has been fed so far as to reach the forming mandrel 12.

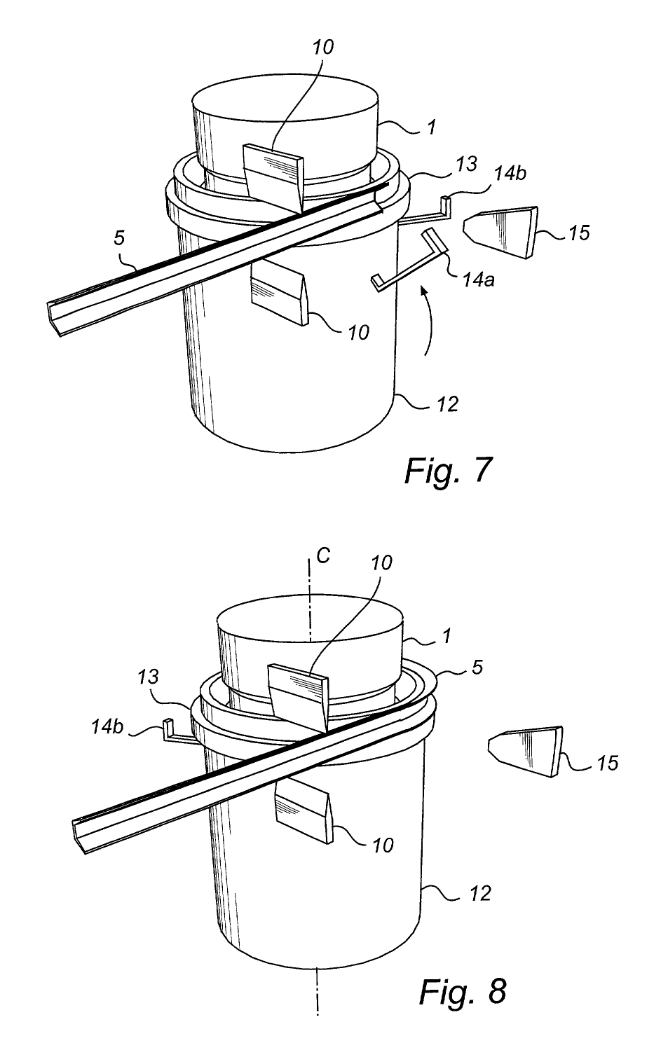

In FIG. 7, the sealing strip 5 is held in place by a first gripping head 14a, so as to prevent the sealing strip 5 from moving relative to the forming mandrel 12.

In FIG. 8, the forming mandrel 12 has begun rotating around its length axis C in a counter clockwise direction, so as to form the sealing gasket. The first end of the sealing strip 5 is being held in place by the first gripping head 14a, so that the sealing strip 5 which is being fed will be wound around the forming mandrel 12.

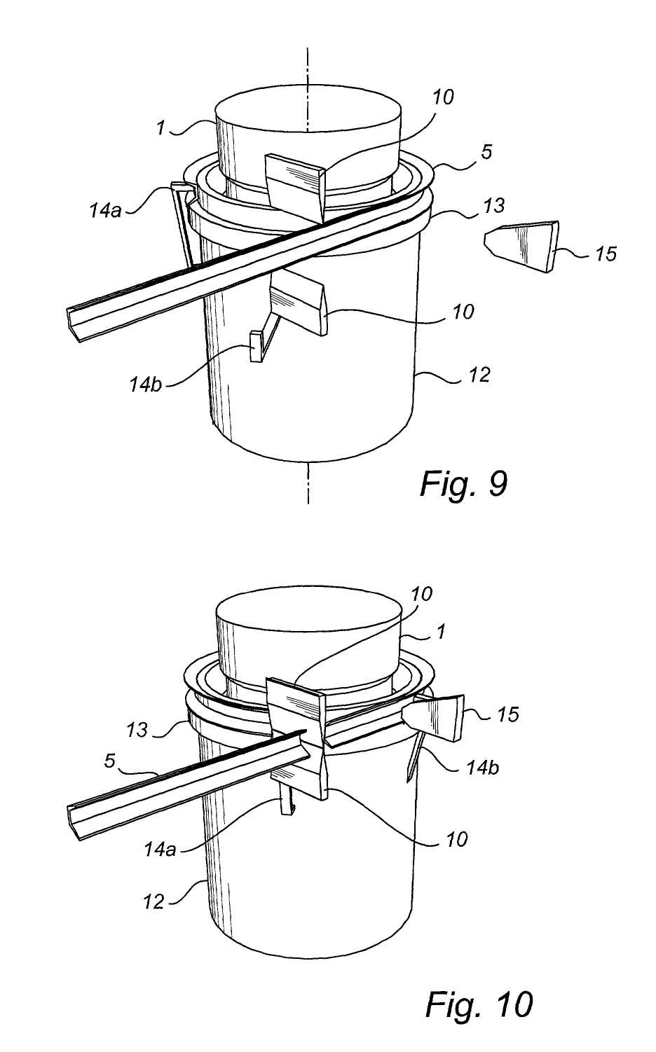

In FIG. 9, the first gripping head 14a holding the first end 8a of the sealing strip 5 against the forming mandrel 12 has almost reached its starting point, i.e. it has almost rotated an entire 360° around the axis C of the forming mandrel 12 and the sealing strip 5 is almost encircling the entire perimeter of the forming mandrel 12.

In FIG. 10, the second gripping head 14b has begun to engage a second portion of the sealing strip 5 in a similar manner as the first gripping head 14a engaged the first end 8a of the sealing strip 5, i.e. by holding it against the forming mandrel 12. Meanwhile, the cutter 10 has been activated so that the sealing strip 5 has been cut into a length which essentially corresponds to that of the forming mandrel or duct component perimeter.

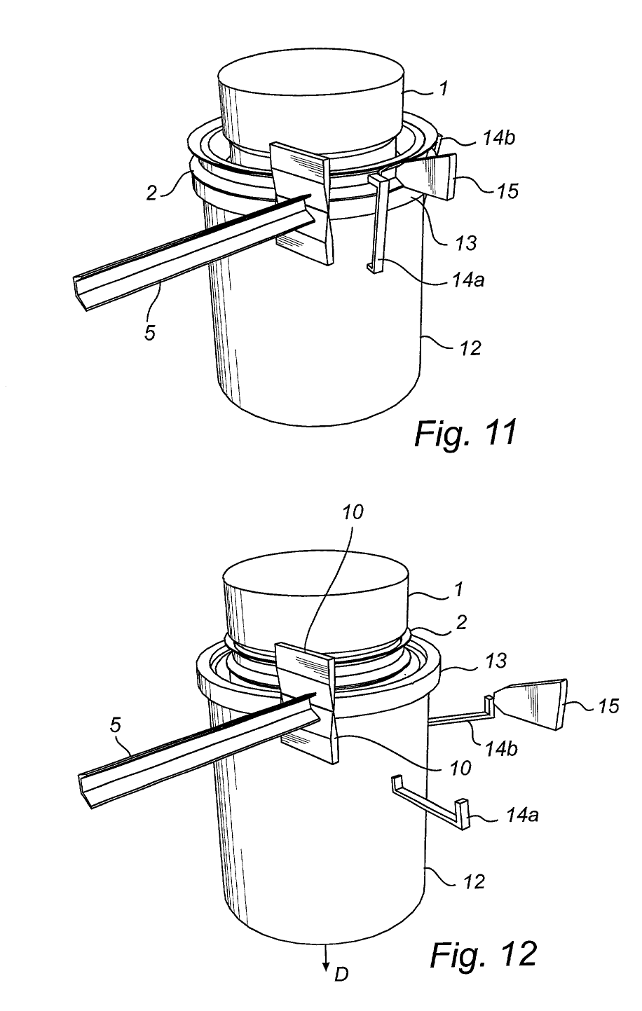

In FIG. 11, the two gripping heads 14a, 14b are holding the two ends 8a, 8b of the sealing strip portion 5, while the joiner 15 has been activated so as to press the second end 8b of the sealing strip portion 5 against the forming mandrel 12, adjacent the first end 8a. The joiner 15 joins the two ends 8a, 8b of the sealing strip portion 5 by e.g. heat treatment, vulcanization, welding, gluing or any similar method. After the joining operation, a certain dwell time may be needed for e.g. allowing the glue to settle or the material to cool off.

After the dwell time, the joiner 15 is deactivated and the two ends 8a, 8b of the sealing strip portion 5 joining have been joined so that a sealing gasket 2 has been formed. The two gripping heads 14a, 14b have also been deactivated, so that the sealing gasket 2 is essentially completed.

In FIG. 12, the forming mandrel 12 has been moved in relation to the abutment 13 so that the sealing gasket 2 is pushed off the forming mandrel 12 and onto the duct component 1, which is positioned so that the sealing gasket 2 is aligned in relation to e.g. the duct component end 3 or groove 6. This operation may be performed by either moving the forming mandrel 12 or by moving the abutment 13.

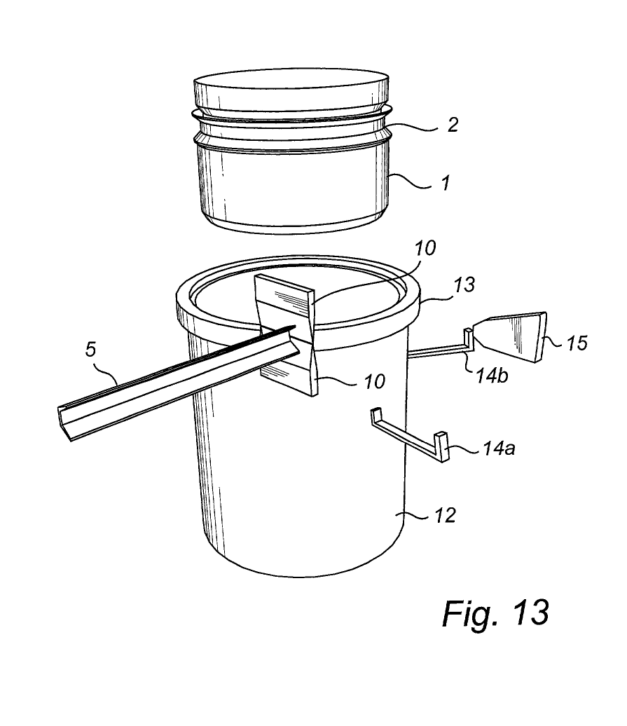

In FIG. 13, the sealing gasket 2 has been transferred to the duct component 1 and the duct component 1 removed from the forming mandrel 12, complete with the sealing gasket 2.

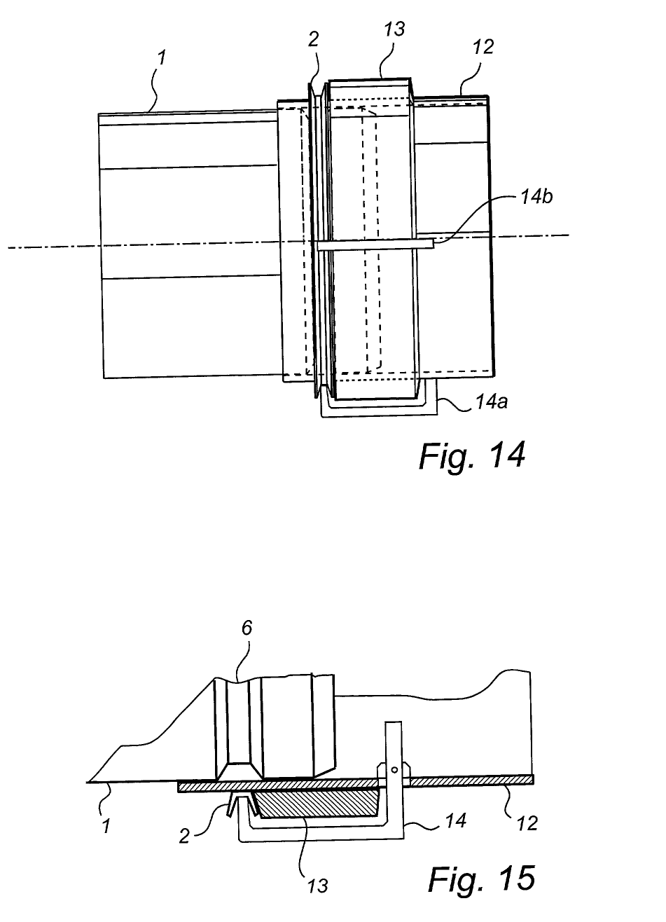

FIG. 14 shows a side view of the production apparatus in the position of FIG. 11, wherein the duct component 1 is inserted in the forming mandrel 12 and the ends of the sealing strip portion 5 have been joined by the joiner 15. In FIG. 14, the duct component 1 has been provided with a circumferential groove 6 for receiving the sealing gasket 2.

FIG. 15 is a more detailed view of the position shown in FIG. 4. The gripping head 14 is holding the sealing gasket 2 in place on the forming mandrel 12 and the duct component 1 is inserted in the forming mandrel 12.

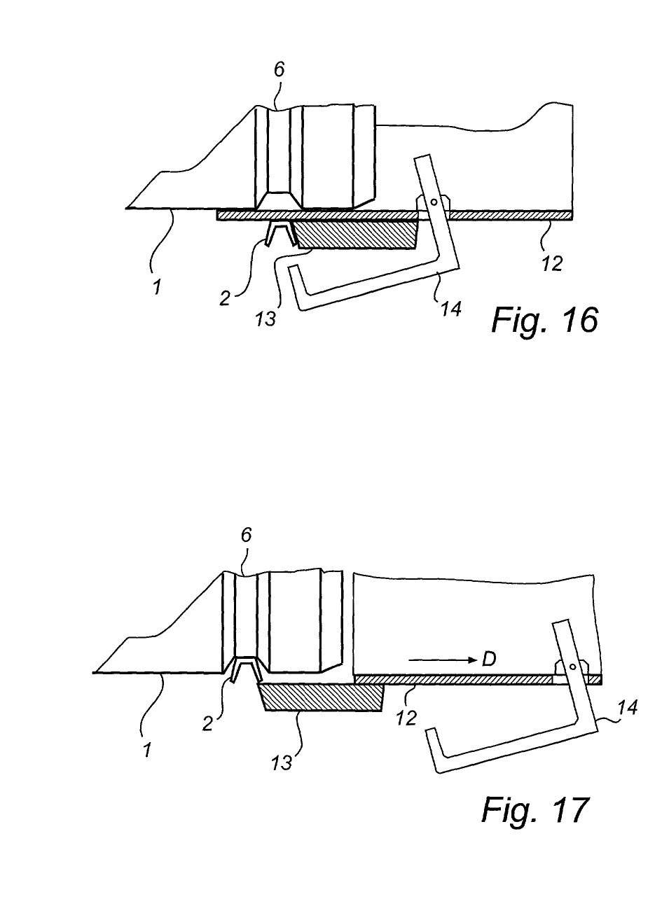

In FIG. 16, the gripping head 14 has been deactivated so as to release the sealing gasket 2.

In FIG. 17, the forming mandrel 12 has been moved in relation to the abutment 13, so that the abutment 13 has forced the sealing gasket 2 over the edge of the forming mandrel 12 and down in the groove 6 of the duct component 1.

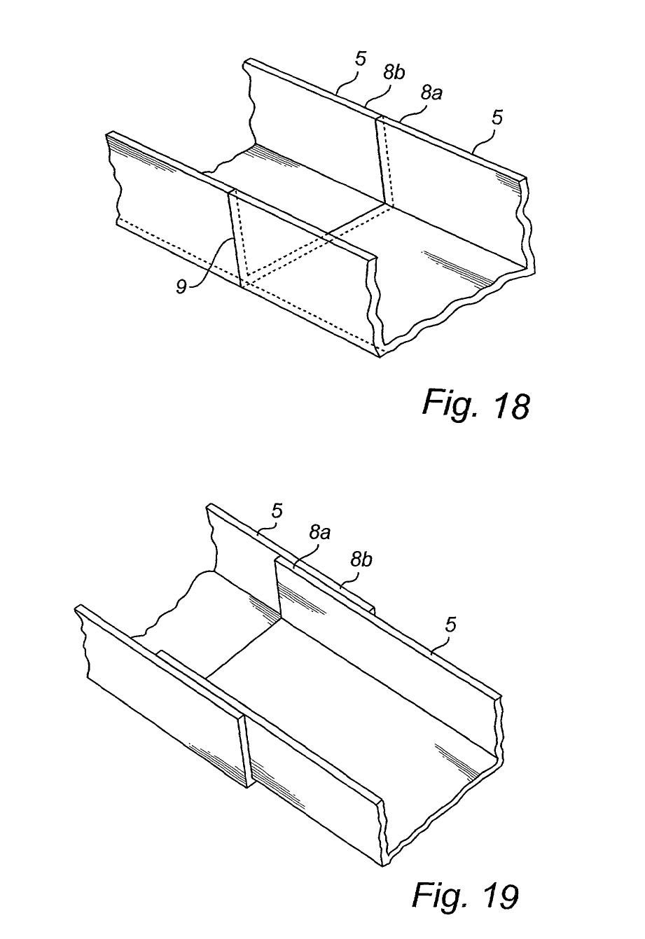

FIG. 18 illustrates a first method of joining the ends 8a, 8b of the sealing strip portion 5 that is to form the sealing gasket 2. The ends 8a, 8b are placed adjacent each other, so as to achieve a continuous profile throughout the joint 9. The ends 8a, 8b are joined together by e.g. gluing, vulcanization, heat treatment or other equivalent methods.

FIG. 19 illustrates a second method of joining the edges of the sealing strip portion that is to form the sealing gasket. The end portions 8a, 8b of the sealing strip portion 5 are placed so that they overlap each other. Subsequently, the end portions 8a, 8b are joined by a similar method as those described above.

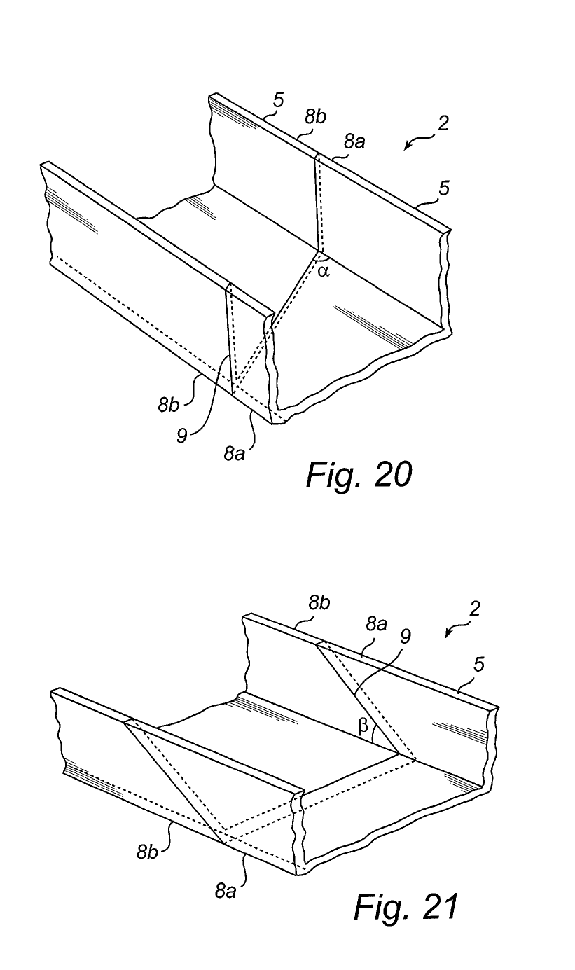

FIG. 20 illustrates a third method of joining the ends 8a, 8b of the sealing strip portion 5 that is to form the sealing gasket 2. According to this method, the ends 8a, 8b of the sealing strip 5 are cut at an angle α relative to the longitudinal direction of the strip other than 90° so that e.g. the splices in the lips of the sealing strip will become offset from each other. This may be advantageous since the two potential leakage points are displaced.

FIG. 21 discloses another way of cutting the end of the sealing strip 5 at an angle β relative to the longitudinal direction of the sealing strip.

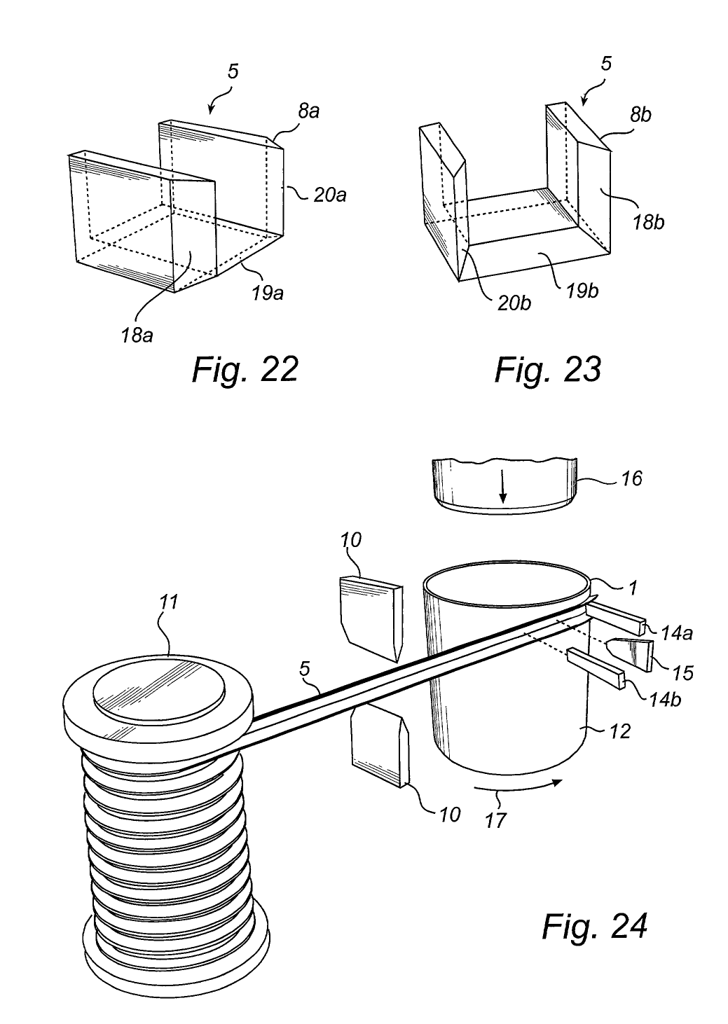

FIGS. 22 and 23 illustrates another way of treating the ends of the strip 5, wherein the ends 8a, 8b of the strip 5 are e.g. skived, beveled or tapered, i.e. they are thinned out towards its ends, so that an optimal splice may be achieved. The skiving of the edge or edges may be achieved in different ways. In a U-shaped strip profile, such as the one discussed above and shown in e.g. FIGS. 20 and 21, each flange may instead be individually skived so as to fit together with the corresponding flange of the edge with which it is to be joined. FIGS. 22 and 23 show an example of how such skived edges 8a and 8b respectively may appear. In this example, the surfaces 18a, 19a and 20a of the first strip end 8a will interact with the surfaces 18b, 19b and 20b respectively of the second strip end 8b. The surfaces may be fastened to each other by any of the above described techniques. It is however understood that the skiving may be achieved in different ways to achieve the same objective.

FIG. 22 shows a first end 8a which is skived so as to remove matter from the outside of the strip end 8a and thus adapting it for being fitted inside a second end 8b of the strip 5.

FIG. 23 shows the second end 8b which is skived so as to remove matter from the inside of the strip end 8b so as to adapting it to receive the first end 8a. The ends 8a, 8b may be fastened to each other in any of the above described ways in order to achieve an annular gasket.

In FIG. 24, an alternative embodiment of an apparatus for arranging the sealing strip around the duct component is illustrated, whereby the sealing strip may be wound directly on the duct component 1 instead of on a forming mandrel. In this case, the duct component is rotated (illustrated by reference numeral 17 in FIG. 24) relative to the sealing strip supply 11. This embodiment may be advantageous since the step of transferring the sealing gasket 2 to the duct component may be abolished. In this case it may also be advantageous to reinforce the duct component during the winding operation, by e.g. inserting a support member 16 inside the opening of the pipe, around which the sealing strip is to be wound. This support member 16 could prevent the duct component from being damaged if the pressure from the gripping heads 14a, 14b is high enough to deform the pipe. The support member 16 may also be arranged between the duct component and the sealing gasket and then removed after the sealing gasket has been completed (not shown).

It is also possible to cut the sealing strip prior to arranging it around the duct component.

In another alternative embodiment, the sealing strip may be tightened around the forming mandrel or pipe. This may be achieved by e.g. setting the feed rate of the sealing strip lower than the circumferential speed of the forming mandrel or duct component, so that the sealing strip is tightened around the forming mandrel or duct component when it rotates (not shown).

Furthermore, the gripping heads 14a, 14b are merely shown schematically in the enclosed drawings. Their actual shape and operating mechanism may be varied within the scope of the invention. They may also be provided with e.g. friction increasing means such as e.g. protrusions or grooves.

The abutment does not need to be a ring around the forming mandrel, but could be one or more rods or pins arranged to move the sealing gasket relative to the forming mandrel, so that it is pushed off the forming mandrel and onto the pipe.

Furthermore, the forming mandrel does not have to have a permanent shape or cross section. Instead, it could be composed of a number of support surfaces which are moveable in relation to each other and around which the sealing strip may be wound. This could enable the use of a single forming mandrel for production several different gasket sizes or shapes.

1. A method of manufacturing a tubular element having a sealing gasket arranged around an external surface thereof, the method comprising the steps of:
providing a continuous sealing strip;
forming the sealing strip into a shape that essentially corresponds to a perimeter of the tubular element;
cutting the sealing strip into a sealing strip portion having a length that essentially corresponds to the perimeter of the tubular element;
joining together a first and a second end of the sealing strip portion, so as to form the sealing gasket; and
fastening the sealing gasket around the perimeter of the tubular element.

2. The method of claim 1, wherein the step of forming the sealing strip comprises:
winding the sealing strip around a forming mandrel having a perimeter that essentially corresponds to a perimeter of the tubular element; and
after joining together the first and second ends of the sealing strip portion, transferring the sealing gasket onto the tubular element.

3. The method of claim 2, wherein the step of forming the sealing strip comprises holding a first end of the sealing strip against a point on the perimeter of the forming mandrel.

4. The method of claim 2, wherein the step of forming the sealing strip around a forming mandrel comprises rotating the forming mandrel around a center axis of the tubular element so as to arrange the sealing strip around the perimeter of the forming mandrel.

5. The method of claim 2, further comprising the step of arranging the first and second ends of the sealing strip portion adjacent each other and held against the forming mandrel.

6. The method of claim 1, wherein the step of forming the sealing strip comprises winding the sealing strip around a perimeter of the tubular element.

7. The method of claim 6, wherein the step of forming the sealing strip comprises rotating the tubular element around a center axis of the tubular element, so as to wind the sealing strip around the perimeter of the tubular element.

8. The method of claim 6, further comprising the step of arranging the first and second ends of the sealing strip portion adjacent each other and held against the tubular element.

9. The method of claim 1, wherein the step of providing a sealing strip comprises providing a continuous sealing strip.

10. The method of claim 1, wherein the step of providing a sealing strip comprises feeding the sealing strip from a supply of such sealing strip.

11. The method of claim 1, wherein the step of cutting the sealing strip comprises cutting it into a length which is essentially equal to the circumference of a portion of the tubular element where the sealing gasket is to be applied.

12. The method of claim 1, wherein the step of joining together the first and second ends of the strip portion comprises arranging them adjacent each other, so as to provide a sealing gasket having a continuous profile.

13. The method of claim 1, wherein the step of joining together the first and second ends of the strip portion comprises arranging them in an overlapping manner.

14. The method of claim 1, wherein the step of joining together the first and second ends of the strip portion comprises one of a gluing operation, a vulcanization operation, a welding operation and a heat treatment operation.

15. The method of claim 1, wherein the step of fastening the sealing strip to the tubular element comprises clamping the sealing strip to the tubular element.

16. The method of claim 1, wherein the step of fastening the sealing strip to the tubular element comprises providing a circumferential groove near the tubular element end portion and arranging the sealing strip in the groove.

17. The method of claim 1, wherein the step of fastening the sealing strip to the tubular element comprises adhering the sealing strip to a surface of the tubular element.

18. The method of claim 1, wherein the step of fastening the sealing strip to the tubular element comprises folding an edge portion of the tubular element so as to squeeze the sealing strip portion with at least one folded edge portion of the tubular element.

19. The method of claim 1, wherein the tubular element is a ventilation duct component.

20. The method of claim 19, wherein the ventilation duct component comprises a thin-walled sheet metal structure.

21. An apparatus for manufacturing a tubular element having a sealing gasket arranged around its external surface, the apparatus comprising:
a sealing strip feeder for feeding a sealing strip;
a sealing strip winder for forming the sealing strip into a sealing gasket for the tubular element;
a cutter for cutting the sealing strip into a sealing strip portion having a length which essentially corresponds to the perimeter of the tubular element; and
a joiner for joining together a first and a second end of the sealing strip portion, so as to form the sealing gasket.

22. The apparatus of claim 21, further comprising a sealing strip supply.

23. The apparatus of claim 21, further comprising a rotator for rotating the tubular element relative to the sealing strip feeder.

24. The apparatus of claim 21, further comprising at least one gripping head for holding the sealing strip against the tubular element.

25. The apparatus of claim 21, wherein the joiner is configured to carry out one of a gluing operation, a vulcanization operation, a welding operation and a heat treatment operation.

26. The apparatus of claim 21, further comprising:
a forming mandrel having a perimeter that essentially corresponds to the perimeter of the tubular element; and
an abutment for transferring the sealing gasket from the forming mandrel onto the tubular element.

27. The apparatus of claim 26, wherein the forming mandrel is rotatably arranged for winding the sealing strip around the forming mandrel.

28. The apparatus of claim 26, further comprising a sealing strip winder arranged to wind the sealing strip around the perimeter of the forming mandrel.

29. The apparatus of claim 28, further comprising at least one gripping head for holding the sealing strip against the forming mandrel.

30. The apparatus of claim 26, wherein the forming mandrel has a variable cross section so as to enable it to produce sealing gaskets having different diameters.

31. An apparatus for manufacturing a tubular element having a sealing gasket around its perimeter, the apparatus comprising:
means for feeding a sealing strip;
means for forming the sealing strip into a sealing gasket for the tubular element;
means for cutting the sealing strip into a sealing strip portion having a length which essentially corresponds to the perimeter of the tubular element; and
means for joining together a first and a second end of the sealing strip portion, so as to form the sealing gasket.

32. The apparatus of claim 31, further comprising:
mandrel means having a perimeter that essentially corresponds to the perimeter of the tubular element; and
means for transferring the sealing gasket from the molding means onto the tubular element.

33. A ventilation duct component comprising a thin-walled, essentially tubular structure having a sealing gasket arranged around its perimeter, said sealing gasket comprising a sealing strip having a profiled cross section and two strip end portions, which are joined together so as to form an essentially continuous sealing gasket.

34. The ventilation duct component of claim 33, wherein the two strip end portions are joined together by one of a gluing operation, a vulcanization operation, a welding operation and a heat treatment operation.

35. The ventilation duct component of claim 33, wherein the sealing gasket is axially fastened to the tubular structure.

36. The ventilation duct component of claim 35, wherein the sealing gasket is axially fastened to the tubular element by a clamping strap that is arranged around the sealing gasket and tightened.

37. The ventilation duct component of claim 35 or 36, wherein the sealing gasket is axially fastened to the tubular element by arranging the sealing gasket in a circumferential groove.

38. The ventilation duct component of claim 37, wherein the sealing gasket is axially fastened to the tubular element by adhering the sealing gasket to a surface of the tubular element.

39. The ventilation duct component of claim 35, wherein the sealing gasket is axially fastened to the tubular element by a folded edge portion of the tubular element, which squeezes at least a part of the sealing gasket between the folded edge portion and a non-folded portion of the tubular element.

40. The ventilation duct component of claim 33, wherein the two strip end portions are arranged in an overlapping manner.

41. The ventilation duct component of claim 33, wherein the two strip end portions are cut at an angle relative to the longitudinal direction of the strip.

42. The ventilation duct component of claim 33, wherein at least one of the two strip end portions is skived.
